(19) United States
(12) Patent Application Publication
(10) Pub. No.: US 2024/0001795 A1
(43) Pub. Date: Jan. 4, 2024

(54) CHARGING MANAGEMENT METHOD, RECORDING MEDIUM, AND CHARGING MANAGEMENT SYSTEM

(71) Applicant: Panasonic Intellectual Property Corporation of America, Torrance, CA (US)

(72) Inventors: Kotaro SAKATA, Osaka (JP); Tetsuji FUCHIKAMI, Osaka (JP)

(21) Appl. No.: 18/367,723

(22) Filed: Sep. 13, 2023

Related U.S. Application Data
(63) Continuation of application No. PCT/JP2022/003382, filed on Jan. 28, 2022.

(30) Foreign Application Priority Data
Mar. 29, 2021 (JP) 2021-055441

(51) Int. Cl. B60L 53/66; B60L 53/65; B60L 53/68; B60L 53/62; B60L 53/64; B60L 58/12

(52) U.S. Cl. CPC B60L 53/66; B60L 53/65; B60L 53/68; B60L 53/62; B60L 53/64; B60L 58/12; B60L 2240/72

(57) ABSTRACT

A charging management method includes obtaining, predicting, and creating. In the obtaining, location information, battery information, and history information are obtained, the location information being information on the location of a traveling object powered by electricity, the battery information being information on the remaining capacity of a storage battery mounted on the traveling object, the history information being information on the charging history of the storage battery. In the predicting, the charging demand of at least one charging facility is predicted on the basis of the location information, the battery information, and the history information obtained in the obtaining. In the creating, a charging plan for charging the storage battery to keep the charging demand less than or equal to a predetermined value is created on the basis of the charging demand predicted in the predicting.

### CROSS REFERENCE TO RELATED APPLICATIONS

This is a continuation application of PCT International Application No. PCT/JP2022/003382 filed on Jan. 28, 2022, designating the United States of America, which is based on and claims priority of Japanese Patent Application No. 2021-055441 filed on Mar. 29, 2021. The entire disclosures of the above-identified applications, including the specifications, drawings and claims are incorporated herein by reference in their entirety.

### FIELD

The present disclosure relates to a charging management method, a recording medium, and a charging management system which are designed to manage charging of the storage battery of a traveling object powered by electricity.

### BACKGROUND

Japanese Patent No. 6085544 relates to a quick charging facility for electric vehicles and a charging facility system, the quick charging facility being connected to a power generator, such as a solar power generation module, or a charge-discharge device, such as a stationary storage battery. Japanese Patent No. 6085544 discloses an energy management method for each device connected to the charging facility.

Japanese Patent No. 5851731 discloses an electric vehicle charging system including a power transmitter and a power receiver. The power transmitter includes a power transmitting unit that is provided below the ground surface and below a protection plate and supplies power by using an electromagnetic induction system. The power receiver charges a storage battery for running an electric vehicle, via a power receiving unit that receives power from the power transmitting unit by electromagnetic induction.

### CITATION LIST

### Patent Literature

PTL 1: Japanese Patent No. 6085544
PTL 2: Japanese Patent No. 5851731

### SUMMARY

### Technical Problem

The present disclosure aims to provide a charging management method, a recording medium, and a charging management system that facilitate leveling of the charging demand of at least one charging facility.

### Solution to Problem

A charging management method according to one aspect of the present disclosure includes obtaining, predicting, and creating. In the obtaining, location information, battery information, and history information are obtained, the location information being information on the location of a traveling object powered by electricity, the battery information being information on the remaining capacity of a storage battery mounted on the traveling object, the history information being information on a charging history of the storage battery. In the predicting, the charging demand of at least one charging facility is predicted based on the location information, the battery information, and the history information obtained in the obtaining. In the creating, a charging plan for charging the storage battery to keep the charging demand less than or equal to a predetermined value is created based on the charging demand predicted in the predicting.

A recording medium according to another aspect of the present disclosure is a non-transitory computer-readable recording medium having recorded thereon a program for causing at least one processor to perform the charging management method.

A charging management system according to still another aspect of the present disclosure includes an obtainer, a predictor, and a planner. The obtainer obtains location information, battery information, and history information, the location information being information on the location of a traveling object powered by electricity, the battery information being information on the remaining capacity of a storage battery mounted on the traveling object, the history information being information on a charging history of the storage battery. The predictor predicts the charging demand of at least one charging facility, based on the location information, the battery information, and the history information obtained by the obtainer. The planner that creates a charging plan for charging the storage battery to keep the charging demand less than or equal to a predetermined value, based on the charging demand predicted by the predictor.

### Advantageous Effects

As an advantage of the present disclosure, it is possible to facilitate leveling of the charging demand of at least one charging facility.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 illustrates an overview of a charging management system according to an embodiment.

FIG. 2 is a block diagram illustrating a configuration of the charging management system according to the embodiment.

FIG. 3 illustrates an example of distribution of charging facilities.

FIG. 4 illustrates an example of charging demand predicated by the predictor of the charging management system according to the embodiment.

FIG. 5 illustrates an example of a screen presenting a charging plan, the screen being the screen of an information terminal according to the embodiment.

FIG. 6 illustrates an example of the screen presenting the result of the completion of charging, the screen being the screen of the information terminal according to the embodiment.

FIG. 7 illustrates an example of the screen suggesting a change of the charging plan, the screen being the screen of the information terminal according to the embodiment.

FIG. 8 is a flowchart illustrating an example of operation of the charging management system according to the embodiment.

### DESCRIPTION OF EMBODIMENT

A charging management method according to one aspect of the present disclosure includes obtaining, predicting, and creating. In the obtaining, location information, battery information, and history information are obtained, the location information being information on the location of a traveling object powered by electricity, the battery information being information on the remaining capacity of a storage battery mounted on the traveling object, the history information being information on a charging history of the storage battery. In the predicting, the charging demand of at least one charging facility is predicted based on the location information, the battery information, and the history information obtained in the obtaining. In the creating, a charging plan for charging the storage battery to keep the charging demand less than or equal to a predetermined value is created based on the charging demand predicted in the predicting.

Thus, the charging demand can be adjusted not to exceed threshold Th1 (the predetermined value), which facilitates leveling of the charging demand of at least one charging facility 3.

For instance, in the creating, the charging plan is created to enable charging of the storage battery during a time period that includes a time period during which the charging demand is less than or equal to a lower limit.

When storage battery 21 is charged preferentially during a time period (time period T2) including a time period during which the charging demand is less than or equal to the lower limit, there is a low possibility of the charging demand during the time period (time period T2) exceeding threshold Th1 (the predetermined value). This facilitates keeping the charging demand less than or equal to threshold Th1.

For instance, the obtaining includes further obtaining reservation information including a charging schedule for charging the storage battery, the reservation information being input by a user of the traveling object. In the creating, when a scheduled charging time period indicated by the reservation information includes a peak time period during which the charging demand exceeds the predetermined value, the charging plan that encourages changing of the scheduled charging time period is created, the scheduled charging time period being included in the charging schedule, the reservation information being information obtained in the obtaining.

Charging storage battery 21 during the time period other than peak time period T1 facilitates keeping the charging demand less than or equal to threshold Th1 (the predetermined value).

For instance, the traveling object has an unmanned autonomous traveling function. The charging management method further includes causing the traveling object to autonomously travel to one of the at least one charging facility and the storage battery to be automatically charged, in accordance with the charging plan created in the creating.

Thus, the user does not have to drive traveling object 2 to charging facility 3 specified by the charging plan or charge storage battery 21 during the time period specified by the charging plan. Accordingly, the user convenience improves.

For instance, in the creating, the charging plan is created to enable charging of the storage battery at a charging facility located in an area within which the traveling object is able to travel within a predetermined time period, the charging facility being one of the at least one charging facility.

Thus, storage battery 21 can be charged at charging facility 3 located in the area within which traveling object 2 can travel within the predetermined time period. Accordingly, after completion of charging, when traveling object 2 travels back to present location P1, traveling object 2 is less likely to waste the charged power.

For instance, in the creating, the charging plan is created to enable charging of the storage battery at a charging facility located in an area within which the traveling object is able to travel within a predetermined distance, the charging facility being one of the at least one charging facility.

Thus, storage battery 21 can be charged at charging facility 3 located in the area within which traveling object 2 can travel within the predetermined distance. Accordingly, after completion of charging, when traveling object 2 travels back to present location P1, traveling object 2 is less likely to waste the charged power.

For instance, in the creating, the charging plan is created to enable charging of the storage battery during a time period based on a schedule of a user of the traveling object.

For instance, storage battery 21 can be charged by effectively using a time period during which the user does not use traveling object 2. Accordingly, it is more likely to avoid a situation in which the user cannot use traveling object 2 due to charging of storage battery 21.

For instance, the charging management method further includes presenting the charging plan created in the creating to a user of the traveling object.

Thus, the user can be aware of the charging plan.

For instance, the presenting includes presenting, to the user, implication information that encourages charging of the storage battery during a time period other than a peak time period during which the charging demand exceeds the predetermined value.

Thus, even if the user made a reservation for peak time period T1 to charge storage battery 21, the user is more likely to change the charging plan so as to charge storage battery 21 during the time period other than peak time period T1.

For instance, the implication information includes information indicating that the unit price of charging the storage battery during the peak time period is higher than the unit price of charging the storage battery during the time period other than the peak time period.

Thus, the user who is concerned about the increase of the unit price of charging storage battery 21 is more likely to change the time period to charge storage battery 21 during the time period other than peak time period T1. Accordingly, the user is more likely to agree with the change of the charging plan.

Furthermore, a recording medium according to another aspect of the present disclosure is a non-transitory computer-readable recording medium having recorded thereon a program for causing at least one processor to perform the charging management method.

Thus, the charging demand can be adjusted not to exceed threshold Th1 (the predetermined value), which facilitates leveling of the charging demand of at least one charging facility 3.

Furthermore, a charging management system according to still another aspect of the present disclosure includes an obtainer, a predictor, and a planner. The obtainer obtains location information, battery information, and history information, the location information being information on the location of a traveling object powered by electricity, the battery information being information on the remaining capacity of a storage battery mounted on the traveling object, the history information being information on a charging history of the storage battery. The predictor predicts the charging demand of at least one charging facility, based on the location information, the battery information, and the history information obtained by the obtainer. The planner that creates a charging plan for charging the storage battery to keep the charging demand less than or equal to a predetermined value, based on the charging demand predicted by the predictor.

Thus, the charging demand can be adjusted not to exceed threshold Th1 (the predetermined value), which facilitates leveling of the charging demand of at least one charging facility 3.

It should be noted that these general or specific aspects may be embodied as a system, a method, an integrated circuit, a computer program, or a recording medium such as a computer-readable CD-ROM or may be embodied by optionally combining the system, the method, the integrated circuit, the computer program, and the recording medium.

An embodiment is described below with reference to the drawings. It should be noted that the embodiment described below shows specific examples of the present disclosure. The numerical values, shapes, materials, structural elements, positions and connections of the structural elements, steps, order of the steps, and other descriptions provided in the embodiment below are mere examples and are not intended to limit the present disclosure. In addition, the structural elements not included in the independent claims representing superordinate concepts, among the structural elements in the embodiment below are described as optional structural elements.

### EMBODIMENT

### 1. Overview

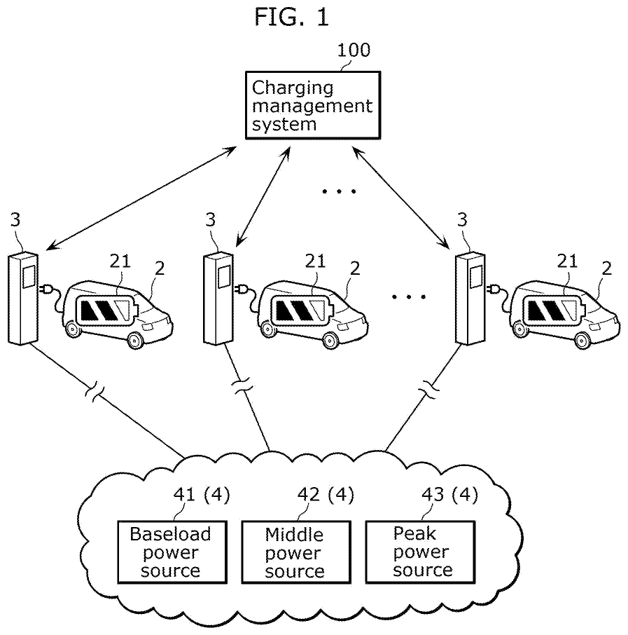

An overview of a charging management system according to an embodiment is described below. FIG. 1 illustrates an overview of charging management system 100 according to the embodiment. As illustrated in FIG. 1, charging management system 100 is designed to manage charging of storage battery 21 of traveling object 2 powered by electricity. Storage battery 21 is charged by supplying power from charging power source 4 to storage battery 21 of traveling object 2 via charging facility (charging point) 3.

Traveling object 2 travels by using electricity stored in storage battery 21 as an energy source and an electric motor as a power source. Traveling object 2 may have energy sources including electricity. For instance, traveling object 2 may be a gasoline-electric hybrid traveling object. In this case, traveling object 2 uses both electricity and gasoline as energy sources. When using electricity as an energy source, traveling object 2 travels by using an electric motor as a power source. When using gasoline as an energy source, traveling object 2 travels by using an internal-combustion engine as a power source. In the embodiment, traveling object 2 is an electrified vehicle, such as an electric vehicle. It should be noted that examples of the electrified vehicle may include a motorcycle or a bicycle in addition to an automobile. In addition to the electrified vehicle, examples of traveling object 2 may include a drone, which is an unmanned aerial vehicle (UAV) and an unmanned flight vehicle capable of autonomously flying.

In the embodiment, traveling object 2 (electrified vehicle) has an unmanned autonomous traveling function (autonomous driving function). For instance, traveling object 2 is equipped with an autonomous driving system equivalent to level 3 or higher defined in SAE J3016: Taxonomy and Definitions for Terms Related to Driving Automation Systems for On-Road Motor Vehicles. Thus, in the embodiment, even in a situation in which a user is not driving traveling object 2, traveling object 2 is capable of autonomously traveling to charging facility 3 and having storage battery 21 automatically charged.

In the embodiment, charging management system 100 manages traveling object 2 belonging to or temporarily rented by the user who made a use contract with the operator of charging management system 100. Charging management system 100 manages traveling objects 2. For instance, charging management system 100 manages tens of thousands of traveling objects 2.

Charging power source 4 is connected to charging facility 3 via a power transmission facility and/or a power transformation facility and supplies power to storage battery 21 mounted on traveling object 2 via charging facility 3. In the embodiment, charging power sources 4 include power sources using different power generation methods. As an example, charging power sources 4 include baseload power source 41, middle power source 42, and peak power source 43.

Baseload power source 41 generally constantly operates to generate and supply power. Baseload power source 41 includes a power source that supplies power generated by, for example, coal-fired power generation, hydraulic power generation, geothermal power generation, or nuclear power generation. The unit price of electricity generated by baseload power source 41 (that is, the cost of power generation per kWh) is lower than that of electricity generated by middle power source 42 and that of electricity generated by peak power source 43.

Middle power source 42 supplies power by operating and generating power when only the power generated by baseload power source 41 cannot meet the power demand. Middle power source 42 includes a power source that supplies power generated by, for example, LNG-fired power generation or LPG-fired power generation. Here, LNG stands for liquefied natural gas, and LPG stands for liquefied petroleum gas. The unit price of electricity generated by middle power source 42 is higher than that of electricity generated by baseload power source 41.

Peak power source 43 supplies power by operating and generating power when the power generated by both baseload power source 41 and middle power source 42 cannot meet the power demand. Peak power source 43 includes a power source that supplies power generated by, for example, oil-fired power generation or pumped storage hydraulic power generation. The unit price of electricity generated by peak power source 43 is higher than that of electricity generated by baseload power source 41 and that of electricity generated by middle power source 42.

It should be noted that in addition to baseload power source 41, middle power source 42, and peak power source 43, charging power sources 4 may include a power source that supplies power generated using a renewable energy source, such as solar light, wind, or biomass.

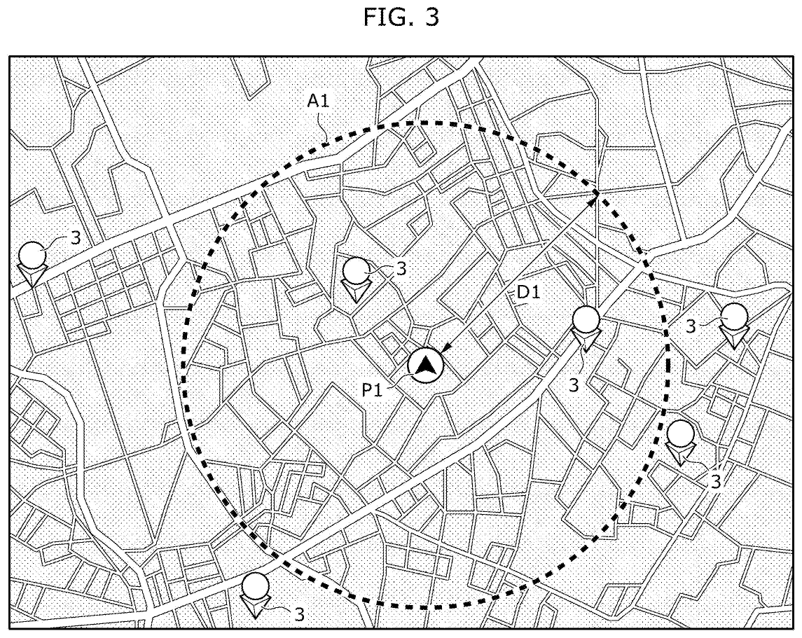

Charging facilities 3 are installed in an area (e.g., throughout a country) in which the operator of charging management system 100 provides services. Charging facilities 3 are installed by the operator or another company which partners with the operator. FIG. 3 illustrates an example of distribution of charging facilities 3. It should be noted that FIG. 3 illustrates only charging facilities 3 managed by charging management system 100. However, in real situations, charging facilities which are not managed by charging management system 100 may be installed. That is, charging facilities 3 in the embodiment are managed by charging management system 100.

In the embodiment, (e.g., thousands of) charging facilities 3 are dispersedly located in the area. It should be noted that just one charging facility 3 may be installed for each installation location, or several charging facilities 3 or more than 10 and less than 20 charging facilities 3 may be installed for each installation location.

In addition to standard chargers, charging facilities 3 may include, for example, quick chargers having greater output than the standard chargers. In the embodiment, charging facility 3 is a wireless power transfer charger. When charging facility 3 is a wireless power transfer charger, storage battery 21 of traveling object 2 can be charged by contactlessly supplying power from a transmitter coil embedded in a road surface to a receiver coil mounted on traveling object 2 by using an electromagnetic induction technology.

It should be noted that in addition to untethered chargers (socket-only chargers), charging facilities 3 may include tethered chargers (cable-attached chargers). When charging facility 3 is an untethered charger, storage battery 21 of traveling object 2 can be charged in the following manner: a plug provided at one end of a charging cable in traveling object 2 is plugged in, and a charging connector provided at the other end of the charging cable is connected to the charging inlet of traveling object 2. When charging facility 3 is a tethered charger, storage battery 21 of traveling object 2 can be charged by connecting a charging connector provided at one end of a charging cable to the charging inlet of traveling object 2. When charging facility 3 is the untethered charger or the tethered charger, as long as traveling object 2 has a mechanism for automatically connecting traveling object 2 to the charger, the storage battery of traveling object 2 can be automatically charged.

### 2. Configuration

Charging management system 100 is described below in detail. Charging management system 100 is, for example, a server. Unless otherwise stated, one traveling object 2 or one user is focused on in the descriptions below. In practice, charging management system 100 performs the processing described below for each traveling object 2 or each user.

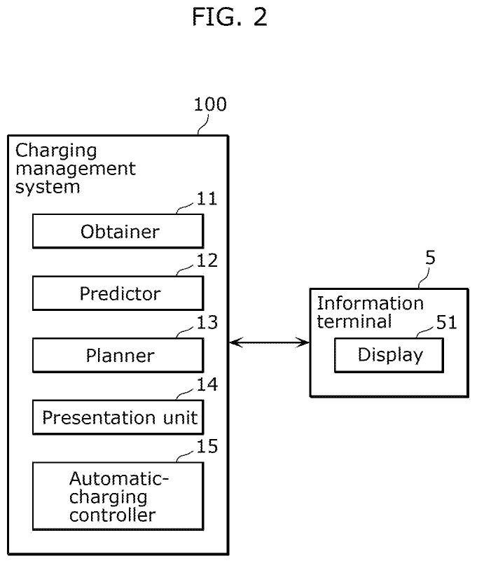

FIG. 2 is a block diagram illustrating a configuration of charging management system 100 according to the embodiment. As illustrated in FIG. 2, charging management system 100 includes obtainer 11, predictor 12, planner 13, presentation unit 14, and automatic-charging controller 15.

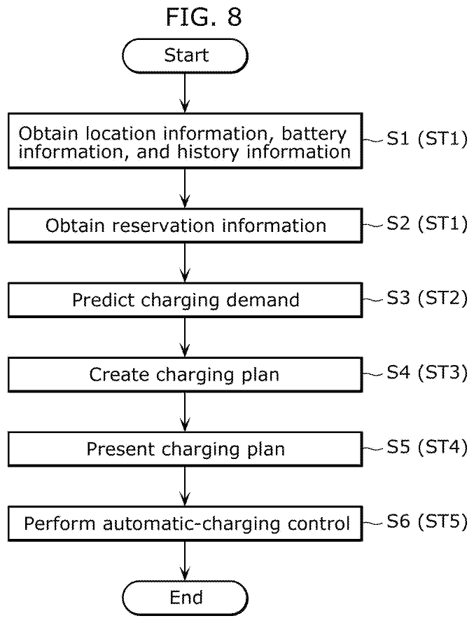

Obtainer 11 obtains location information on the location of traveling object 2, battery information on the remaining capacity of storage battery 21 mounted on traveling object 2, and history information on the charging history of traveling object 2. Obtainer 11 performs obtainment step ST1 (see FIG. 8) in a charging management method. The location information includes, for example, the coordinates of the present location of traveling object 2 measured by a positioning system such as a global position system (GPS). The battery information may include, for example, the current remaining capacity of storage battery 21 or the chargeable capacity of storage battery 21 obtained by subtracting the current remaining capacity from the full capacity of storage battery 21. The battery information may also include state of charge (SoC).

The history information includes, for example, the places where storage battery 21 was previously charged, the time periods during which storage battery 21 was charged, and the amount of power charged in each charging session. It should be noted that the history information does not have to include data on all previous charging sessions. The history information may include data on charging sessions performed during a past predetermined period. In this case, the history information does not include data on the charging sessions performed before the predetermined period.

Obtainer 11 periodically obtains the location information on the location of traveling object 2, the battery information, and the history information from a server operated by the manufacturer of traveling object 2, by, for example, making a request to the server via a communication network such as the Internet. This is because the manufacturer manages the state of traveling object 2 by periodically obtaining, from traveling object 2, the location information, the battery information, and the history information. It should be noted that obtainer 11 may directly obtain the location information, the battery information, and the history information, by communicating with traveling object 2 via a communication network.

In the embodiment, obtainer 11 (obtainment step ST1) further obtains reservation information including a charging schedule for charging storage battery 21, the reservation information being input by the user of traveling object 2. The charging schedule includes the time period during which the user wants to charge storage battery 21 and charging facility 3 with which the user wants to charge storage battery 21. By communicating with information terminal 5 of the user via a communication network, obtainer 11 obtains the reservation information input by the user using information terminal Information terminal 5 may be, a portable terminal such as a smartphone or a tablet terminal. Information terminal 5 may also be a stationary terminal such as a desktop or laptop personal computer.

In the embodiment, a dedicated application for using charging management system 100 is installed onto information terminal 5. By operating information terminal 5 and starting the application, the user can make a reservation for charging storage battery 21 at desired charging facility 3 during a desired time period.

Specifically, when the user operates information terminal 5 and starts the application, a reservation screen appears on display 51 of information terminal 5. By, for example, user's finger touch on display 51, the user performs input to specify desired charging facility 3 and input to specify the desired time period. Then, information terminal 5 generates reservation information and transmits a signal including the generated reservation information to charging management system 100 via the communication network. By receiving the signal, obtainer 11 obtains the reservation information.

Predictor 12 predicts the charging demand of at least one charging facility 3 (here, charging facilities 3) on the basis of the location information, the battery information, and the history information obtained by obtainer 11 (obtainment step ST1). Predictor 12 performs prediction step ST2 in the charging management method. The charging demand is the total amount of power predicted to be consumed in the future at each charging facility 3 to charge storage batteries 21. The amount of power is predicted, for example, for each of separated time periods, such as the morning, or for each hour.

Predictor 12 predicts the charging demand of at least one charging facility 3 by calculating the amount of power estimated to be consumed in the future at each charging facility 3, on the basis of, for example, the location information (the present location of traveling object 2), the battery information (the remaining capacity of storage battery 21), and the history information (the places where storage battery 21 was previously charged, the time periods during which storage battery 21 was charged, and the amount of power charged in each charging session) which are obtained from each traveling object 2.

It should be noted that after obtainer 11 obtains the reservation information, predictor 12 predicts the charging demand on the further basis of the reservation information. It should be noted that by referring to the reservation information, predictor 12 can recognize future charging demand during the specified time period. The charging demand is not predicted charging demand but almost determined charging demand. Thus, by predictor 12 further referring to the reservation information, improvement of the accuracy of prediction of the charging demand can be expected.

On the basis of the charging demand predicted by predictor 12 (prediction step ST2), planner 13 creates a charging plan for charging storage battery 21 to keep the charging demand less than or equal to a predetermined value. Planner 13 performs planning step ST3 in the charging management method. The charging plan is created for each storage battery 21, that is, for each user. In the embodiment, storage battery 21 of each traveling object 2 is charged during a time period specified by the corresponding charging plan at charging facility 3 specified by the corresponding charging plan. That is, automatic-charging controller 15, which is described later, causes each traveling object 2 to autonomously travel to charging facility 3 specified by the corresponding charging plan and has storage battery 21 charged during the time period specified by the corresponding charging plan.

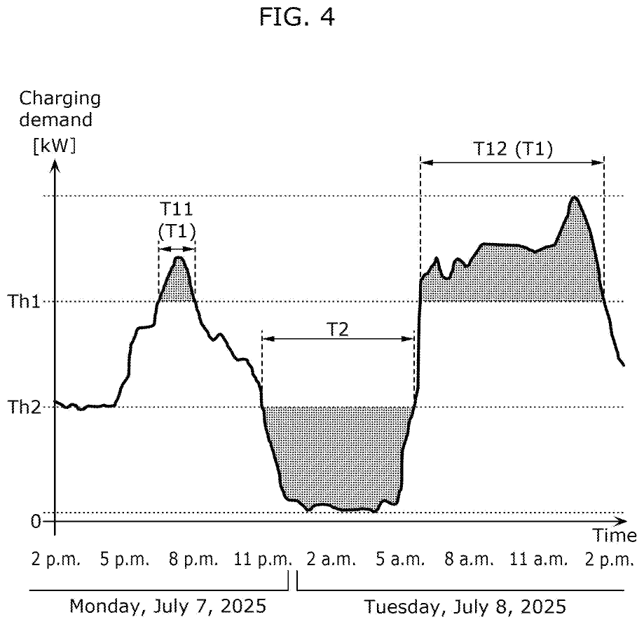

The process in which planner 13 (planning step ST3) creates the charging plan is described below with reference to FIG. 4. FIG. 4 is an example of the charging demand predicted by predictor 12 of charging management system 100 according to the embodiment. In FIG. 4, the vertical axis indicates the charging demand (kW) of at least one charging facility 3 (here, charging facilities 3), and the horizontal axis indicates the time. As an example, FIG. 4 shows the charging demand predicted by predictor 12 at 1 p.m. on Monday, Jul. 7, 2025. Here, the charging demand predicted by predictor 12 shows the charging demand from 2 p.m. on Jul. 7, 2025 to 2 p.m. on Jul. 8, 2025.

In FIG. 4, threshold Th1 indicates the upper limit (a predetermined value) of the charging demand set by charging management system 100 (the charging management method). For instance, when the charging demand exceeds threshold Th1, the extra demand cannot be met without operating middle power source 42 or operating both middle power source 42 and peak power source 43. In FIG. 4, threshold Th2 indicates the lower limit (a predetermined value) of the charging demand set by charging management system 100 (the charging management method).

In the example illustrated in FIG. 4, time period T11 is from 7 p.m. to 9 p.m. on Monday, Jul. 7, 2025, and time period T12 is from 6 a.m. to 2 p.m. on Tuesday, Jul. 8, 2025. Each of time period T11 and time period T12 is peak time period T1 during which the charging demand exceeds threshold Th1 (the predetermined value). Thus, planner 13 creates, for each storage battery 21, a charging plan for causing the charging demand during each of time periods T11 and T12 to be below threshold Th1.

For instance, planner 13 creates, for some of storage batteries 21, charging plans that each specify a time period other than time periods T11 and T12. For instance, regarding storage batteries 21 for which time periods T11 and T12 are reserved, among storage batteries 21, planner 13 creates charging plans that encourage a change from reserved time periods T11 and T12 to time periods other than time periods T11 and T12. That is, when a scheduled charging time period indicated by the reservation information obtained by obtainer 11 (obtainment step ST1) includes peak time period T1, during which the charging demand exceeds threshold Th1 (the predetermined value), planner 13 (planning step ST3) creates charging plans that encourage changing of the scheduled charging time period.

In the embodiment, planner 13 creates a charging plan for charging storage battery 21 preferentially during time period T2 during which the charging demand falls below threshold Th2. That is, planner 13 (planning step ST3) creates a charging plan for charging storage battery 21 during time period T2 including the time period during which the charging demand is less than or equal to the lower limit. For instance, assume a case in which planner 13 created a charging plan for charging storage battery 21 during a time period close to time periods T11 and T12. In this case, by charging storage battery 21 during the time period, the charging demand during the time period may exceed threshold Th1 (the predetermined value). Meanwhile, if storage battery 21 is charged preferentially during time period T2 during which the charging demand falls below threshold Th2, there is a low possibility of the charging demand exceeding threshold Th1 during time period T2. This facilitates keeping the charging demand less than or equal to threshold Th1.

In the embodiment, according to the situation in which traveling object 2 is placed, planner 13 specifies charging facility 3 with which storage battery 21 is to be charged. For instance, as illustrated in FIG. 3, planner 13 may specify charging facility 3 present inside virtual circle A1 as charging facility 3 with which storage battery 21 is to be charged. Here, present location P1 of traveling object 2 corresponds to the center of virtual circle A1, and predetermined distance D1 corresponds to the radius of virtual circle A1. Predetermined distance D1 is, for example, around several kilometers. That is, planner 13 (planning step ST3) may create a charging plan for charging storage battery 21 at charging facility 3 located in an area within which traveling object 2 can travel within the predetermined distance, charging facility 3 being one of at least one charging facility 3 (here, charging facilities 3).

For instance, as charging facility 3 with which storage battery 21 is to be charged, planner 13 may specify charging facility 3 located in an area within which traveling object 2 can travel from present location P1 within a predetermined time period (e.g., around several tens of minutes to one hour). That is, planner 13 (planning step ST3) may create a charging plan for charging storage battery 21 at charging facility 3 located in the area within which traveling object 2 can travel within the predetermined period, charging facility 3 being one of at least one charging facility 3 (here, charging facilities 3).

If charging facility 3 relatively far from present location P1 of traveling object 2 is specified as charging facility 3 with which storage battery 21 is to be charged, traveling object 2 may waste charged power by traveling to and back from charging facility 3 to charge storage battery 21 at charging facility 3. In contrast, if storage battery 21 is charged at charging facility 3 located in the area within which traveling object 2 can travel within the predetermined distance (or the predetermined time period), traveling object 2 is less likely to waste charged power when traveling back to present location P1 after completion of charging.

In a case where for instance planner 13 (planning step ST3) can obtain the schedule of the user of traveling object 2, planner 13 may create a charging plan for charging storage battery 21 during a time period based on the schedule. Specifically, planner 13 may create a charging plan for charging storage battery 21 during a time period other than the time period during which the user is scheduled to use traveling object 2. In this case, for instance, storage battery 21 can be charged by effectively using the time period during which the user does not use traveling object 2, which makes it easier to avoid the situation in which the user cannot use traveling object 2 due to charging of storage battery 21.

Presentation unit 14 presents the charging plan created by planner 13 (in planning step ST3) to the user of traveling object 2. Presentation unit 14 performs presentation step ST4 in the charging management method. Specifically, presentation unit 14 generates presentation information including the time period specified by the charging plan and the location information of charging facility 3 specified by the charging plan. Then, presentation unit 14 transmits a signal including the generated presentation information to information terminal 5 via the communication network. When receiving the signal, information terminal 5 causes display 51 to display the presentation information included in the signal. That is, presentation unit 14 presents the charging plan to the user via information terminal 5.

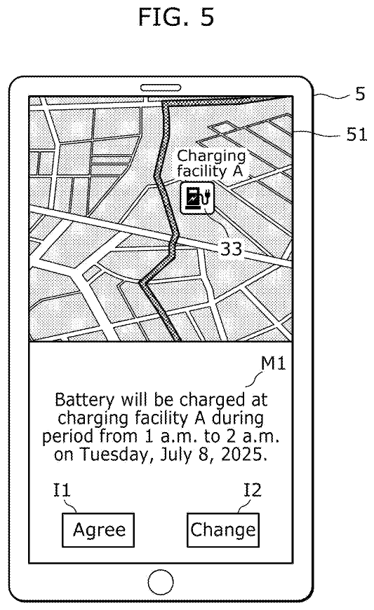

FIG. 5 illustrates an example of a screen presenting a charging plan, the screen being the screen of information terminal 5 according to the embodiment. After planner 13 creates the charging plan, the screen illustrated in FIG. 5 is presented to the user. In the example illustrated in FIG. 5, display 51 is displaying a map including present location P1 of traveling object 2 and the installation location of charging facility A which is charging facility 3 specified by the charging plan. In addition, display 51 is displaying message M1, first icon I1, and second icon I2. Here, message M1 indicates that “Battery will be charged at charging facility A during period from 1 a.m. to 2 a.m. on Tuesday, Jul. 8, 2025.” First icon I1 includes the character string of “Agree.” Second icon I2 includes the character string of “Change.”

By looking at the screen illustrated in FIG. 5 displayed on display 51 of information terminal 5, the user can be aware of the charging plan. If the user can agree with the presented charging plan, the user selects first icon I1 by, for example, finger touch on display 51. In this case, automatic-charging controller 15 controls traveling object 2 in accordance with the charging plan presented to the user. Meanwhile, if the user wants to change the presented charging plan, the user selects second icon I2. In this case, the user may change the charging plan by operating information terminal 5. Alternatively, planner 13 may create a charging plan again, and presentation unit 14 may present the newly created charging plan.

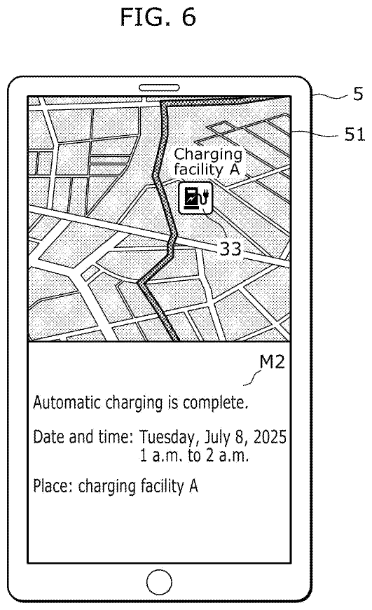

FIG. 6 illustrates an example of the screen presenting the result of the completion of charging, the screen being the screen of information terminal 5 according to the embodiment. The screen illustrated in FIG. 6 is presented to the user after storage battery 21 is automatically charged in accordance with the charging plan. In the example illustrated in FIG. 6, display 51 is displaying a map, as with the example illustrated in FIG. 5. Display 51 is displaying message M2 that includes the character string of “Automatic charging is complete.”, a character string indicating the date and time at which the battery was charged, and a character string indicating the place where the battery was charged. By looking at the screen illustrated in FIG. 6 displayed on display 51 of information terminal 5, the user can be aware of the completion of charging of storage battery 21.

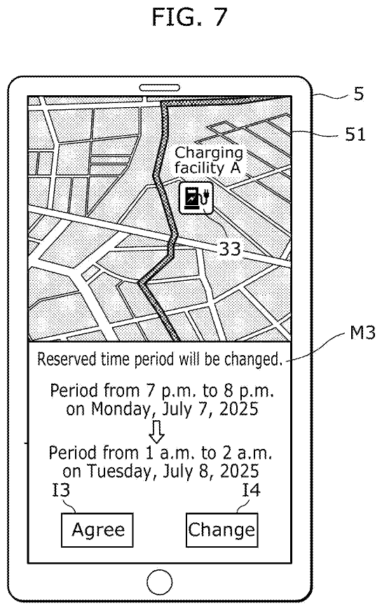

FIG. 7 illustrates an example of the screen suggesting a change of the charging plan, the screen being the screen of information terminal 5 according to the embodiment. The screen illustrated in FIG. 7 is presented to the user when the user made a reservation for charging storage battery 21 and the reserved time period is included in peak time period T1. In the example illustrated in FIG. 7, display 51 is displaying a map, as with the example illustrated in FIG. 5. In addition, display 51 is displaying message M3, third icon I3, and fourth icon I4. Here, message M3 includes the character string of “Reserved time period will be changed.”, a character string indicating the reserved time period before the change, and a character string indicating the reserved time period after the change. Third icon I3 includes the character string of “Agree”, and fourth icon I4 includes the character string of “Change.” That is, in the example, presentation unit 14 (presentation step ST4) is presenting, to the user, implication information that encourages charging of storage battery 21 during a time period other than peak time period T1, during which the charging demand exceeds threshold Th1 (the predetermined value).

It should be noted that the implication information may include, for example, information indicating that the unit price of charging storage battery 21 during peak time period T1 is higher than that of charging storage battery 21 during the time period other than peak time period T1. For instance, display 51 of information terminal 5 may display, as the implication information, a message indicating, for example, “If the battery is charged during the reserved time period before the change, the unit price of charging may increase.” In this way, the user who is concerned about the increase of the unit price of charging storage battery 21 is more likely to change the time period so as to charge storage battery 21 during a time period other than peak time period T1. Accordingly, the user is more likely to agree with the change of the charging plan.

By looking at the screen illustrated in FIG. 7 displayed on display 51 of information terminal 5, the user can be aware of the changed charging plan. If the user can agree with the presented changed charging plan, the user selects third icon I3 by, for example, finger touch on display 51. In this case, automatic-charging controller 15 controls traveling object 2 in accordance with the changed charging plan presented to the user. Meanwhile, if the user wants to further change the presented changed charging plan, the user selects fourth icon I4. In this case, the user may change the charging plan by operating information terminal 5. Alternatively, planner 13 may create a charging plan again, and presentation unit 14 may present the newly created charging plan.

In accordance with the charging plan created by planner 13 (in planning step ST3), automatic-charging controller 15 causes traveling object 2 to travel to one of at least one charging facility 3 (here, charging facilities 3) and has storage battery 21 automatically charged. Automatic-charging controller 15 performs automatic-charging control step ST5 in the charging management method.

Specifically, in accordance with the charging plan created by planner 13, automatic-charging controller 15 generates control information including an instruction to cause the traveling object to travel to charging facility 3 specified by the charging plan and an instruction to charge storage battery 21 during the time period specified by the charging plan. Automatic-charging controller 15 then transmits a signal including the generated control information to traveling object 2 via the communication network. When receiving the signal, in accordance with the control information included in the signal, traveling object 2 autonomously travels to specified charging facility 3 and has storage battery 21 automatically charged during the specified time period. After completion of automatic charging of storage battery 21, traveling object 2 autonomously travels back to the original location (that is, present location P1).

When for instance charging facility 3 is a wireless power transfer charger, storage battery 21 is automatically charged by traveling object 2 parking at the position opposite the transmitter coil, embedded in the road surface, of charging facility 3. When for instance charging facility 3 is an untethered charger or a tethered charger, storage battery 21 is automatically charged by traveling object 2 parking near charging facility 3 and automatically connecting to the charger.

### 3. Operation

An example of operation of charging management system 100 (the charging management method) according to the embodiment is described below with reference to FIG. 8. FIG. 8 is a flowchart illustrating an example of operation of charging management system 100 according to the embodiment. The following descriptions are based on the assumption that the user of traveling object 2 agrees with the charging plan presented by presentation unit 14.

Obtainer 11 periodically obtains the location information, the battery information, and the history information from traveling object 2 (S1). Processing step S1 is performed independently from other processing steps described below. Obtainer 11 obtains the reservation information, by receiving the signal including the reservation information transmitted from information terminal 5 (S2). Processing step S2 is performed only when the user operated information terminal 5 and made a reservation for charging storage battery 21. Processing steps S1 and S2 correspond to obtainment step ST1 in the charging management method.

Predictor 12 predicts the charging demand of at least one charging facility 3 (here, charging facilities 3) on the basis of the location information, the battery information, the history information, and the reservation information obtained by obtainer 11 (S3). Processing step S3 corresponds to prediction step ST2 in the charging management method. Processing step S3 is performed, for example, every time obtainer 11 obtains location information and other information items.

On the basis of the charging demand predicted by predictor 12, planner 13 creates a charging plan for charging storage battery 21 to keep the charging demand less than or equal to threshold Th1 (the predetermined value) (S4). Processing step S4 corresponds to planning step ST3 in the charging management method. Processing step S4 is performed, for example, every time predictor 12 predicts the charging demand.

Presentation unit 14 presents the charging plan created by planner 13 to the user of traveling object 2 (S5). Processing step S5 corresponds to presentation step ST4 in the charging management method. Specifically, presentation unit 14 generates presentation information including the time period specified by the charging plan and the location information of charging facility 3 specified by the charging plan. Then, presentation unit 14 transmits a signal including the generated presentation information to information terminal 5 via the communication network. Processing step S5 is performed, for example, when planner 13 creates the charging plan for the first time and when the charging plan created by planner 13 is changed from a previously created charging plan.

Automatic-charging controller 15 performs automatic-charging control in accordance with the charging plan created by planner 13 (S6). In the automatic-charging control, automatic-charging controller 15 causes traveling object 2 to autonomously travel to one of at least one charging facility 3 (here, charging facilities 3) and has storage battery 21 automatically charged. Processing step S6 corresponds to automatic-charging control step ST5 in the charging management method. Processing step S6 is performed, for example, under the circumstances that the user has agreed with the charging plan and the time period specified by the charging plan approaches.

The series of the processing steps is repeated.

### 4. Advantages

Advantages of charging management system 100 (the charging management method) according to the embodiment are described below. To meet the charging demand as illustrated in FIG. 4, one or more power sources need to be secured for each charging facility 3. The cost of securing the one or more power sources may vary depending on the charging demand. For instance, when the charging demand is relatively low, operating only baseload power source 41 can meet the charging demand. In this case, since the unit price of electricity generated by baseload power source 41 is low, the cost of securing the power source is also low.

Meanwhile, when the charging demand is relatively high, such as a case in which the charging demand exceeds threshold Th1 (the predetermined value), operating only baseload power source 41 cannot meet the charging demand. Thus, middle power source 42 needs to be temporarily operated, and in some cases, peak power source 43 further needs to be temporarily operated. In this case, even if operation of middle power source 42 and/or operation of peak power source 43 is temporary operation, since the cost of securing the power source(s) is calculated on the basis of the unit price of electricity generated by middle power source 42 and/or the unit price of electricity generated by peak power source 43, the cost of securing the power source(s) can be very high.

Accordingly, it is important to level the charging demand to avoid operating middle power source 42 and/or peak power source 43. Here, to level the charging demand is to reduce variations in the charging demand that may vary depending on the time period or the season. Specifically, to level the charging demand is to cause the change of charging demand to be within a specified range.

With regard to this point, charging management system 100 (the charging management method) according to the embodiment can predict the charging demand of at least one charging facility 3. On the basis of the predicted charging demand, charging management system 100 can create charging plans for charging storage batteries 21 to keep the charging demand less than or equal to threshold Th1 (the predetermined value). That is, in the embodiment, the charging demand can be adjusted not to exceed threshold Th1, which facilitates leveling of the charging demand of at least one charging facility 3. Thus, in the embodiment, it is more likely to meet the charging demand without operating middle power source 42 and/or peak power source 43. As a result, it is more likely to suppress the costs of securing one or more power sources.

### Variation

Charging management system 100 (charging management method) according to the embodiment is described above. However, the present disclosure is not limited to the descriptions in the embodiment.

In the embodiment, by further referring to a history of past traffic volume in each of the areas where charging facilities 3 are installed, predictor 12 (prediction step ST2) may predict the charging demand of at least one charging facility 3.

In the embodiment, there is no need to inquire of the user of traveling object 2 to obtain user's approval for a charging plan created by planner 13 (in planning step ST3). In this case, charging management system 100 does not have to include presentation unit 14. In other words, the charging management method does not have to include presentation step ST4.

In addition, in the embodiment, traveling object 2 does not have to have the autonomous traveling function. In this case, the user drives traveling object 2 to charging facility 3 specified by the charging plan and charge storage battery 21 during the time period specified by the charging plan. In this case, charging management system 100 does not have to include automatic-charging controller 15. In other words, the charging management method does not have to include automatic-charging control step ST5.

In the embodiment, charging management system 100 (the charging management method) may further include a power source securing unit (a power source securing step). The power source securing unit (the power source securing step) secures one or more charging power sources 4 for each of charging facilities 3 on the basis of the charging demand predicted by predictor 12 (prediction step ST2). The power source securing unit secures one or more charging power sources 4 for each charging facility 3 to avoid future shortage of power necessary to charge storage batteries 21 at charging facility 3.

Methods of securing charging power source 4 may include, for example, a method of securing charging power source 4 (e.g., a power plant) held by the operator of charging management system 100. The methods of securing charging power source 4 may include a method of securing charging power source 4 from a power provider holding charging power source 4, by having a power purchase agreement with the power provider. The methods of securing charging power source 4 may include a method of securing charging power source 4 purchased from an electric power wholesale market (e.g., Japan electric power exchange (JEPX) in Japan). The power source securing unit (the power source securing step) secures one or more charging power sources 4 for each charging facility 3, by using at least one of the power source securing methods described above.

It should be noted that the power source securing unit (the power source securing step) may use different securing methods for the respective types of charging power sources 4. For instance, the power source securing unit may secure baseload power source 41 held by a first power provider and secure middle power source 42 held by a second power provider different from the first power provider.

In addition, the power source securing unit (the power source securing step) may secure one or more charging power sources 4 so as to meet the entire charging demand of each charging facility 3 or so as to meet a power shortage at each charging facility 3.

In the embodiment, machine learning may be used for calculation of the charging demand by predictor 12. For instance, the machine learning is performed using, as input, various parameters, such as time periods, and the histories of past charging sessions. It should be noted that the charging demand changes as the time elapses. Thus, the machine learning may be performed in a state in which a newer parameter and newer data are given a higher priority.

It should be noted that in the embodiment, charging facility 3 may be, for example, a road in which a transmitter coil is embedded. In this case, storage battery 21 can be charged while traveling object 2 is traveling on the road.

The processing elements included in, for example, charging management system 100 according to the embodiment are typically embodied as LSIs, which are integrated circuits. The processing elements may be made as individual chips, or a part or all of the elements may be incorporated into one chip.

Circuit integration is achieved not only by an LSI but also by a dedicated circuit or a general-purpose processor. A field programmable gate array (FPGA) which can be programmed after manufacturing an LSI or a reconfigurable processor in which the connections and settings of circuit cells inside an LSI are reconfigurable may be used.

In the embodiment, each of the structural elements may be dedicated hardware or may be caused to function by executing a software program suitable for the structural element. The structural element may be caused to function by a program executer, such as a CPU or a processor, reading and executing a software program stored in a recording medium, such as a hard disk or semiconductor memory.

All the numbers used in the above descriptions are provided as examples to specifically explain the present disclosure. The present disclosure is not limited to the numbers provided as examples.

The configuration of the functional blocks illustrated in the block diagram is a mere example. Two or more functional blocks may be incorporated into one functional block. One functional block may be divided into more than one functional block. A part of the function may be transferred from one functional block to another functional block. The same hardware or software may process, in parallel or on a time-sharing basis, the functions of two or more functional blocks having similar functions.

The order in which the steps in the flowchart are performed is provided as an example to specifically explain the present disclosure. The steps may be performed in a different order. In addition, a part of the steps and another step may be performed simultaneously (in parallel).

For instance, in the embodiment, charging management system 100 is described as a single device. However, charging management system 100 may be embodied as two or more devices. When charging management system 100 is embodied as two or more devices, it does not matter how the structural elements of charging management system 100 are distributed among the two or more devices. The present disclosure may be achieved by cloud computing or edge computing.

The charging management system according to one or more aspects is described above. However, the present disclosure is not limited to the descriptions in the embodiment. The present disclosure includes, within the scope of the present disclosure, one or more embodiments obtained by making various changes envisioned by those skilled in the art to the embodiment and one or more embodiments obtained by combining some of the structural elements described in different embodiments.

### INDUSTRIAL APPLICABILITY

The present disclosure can be used in, for example, a system that manages charging of the storage battery of a traveling object powered by electricity.

1. A charging management method comprising:
obtaining location information, battery information, and history information, the location information being information on a location of a traveling object powered by electricity, the battery information being information on a remaining capacity of a storage battery mounted on the traveling object, the history information being information on a charging history of the storage battery;
predicting a charging demand of at least one charging facility, based on the location information, the battery information, and the history information obtained in the obtaining; and
creating a charging plan for charging the storage battery to keep the charging demand less than or equal to a predetermined value, based on the charging demand predicted in the predicting.

2. The charging management method according to claim 1,
wherein in the creating, the charging plan is created to enable charging of the storage battery during a time period that includes a time period during which the charging demand is less than or equal to a lower limit.

3. The charging management method according to claim 1,
wherein the obtaining includes further obtaining reservation information including a charging schedule for charging the storage battery, the reservation information being input by a user of the traveling object, and
in the creating, when a scheduled charging time period indicated by the reservation information includes a peak time period during which the charging demand exceeds the predetermined value, the charging plan that encourages changing of the scheduled charging time period is created, the scheduled charging time period being included in the charging schedule, the reservation information being information obtained in the obtaining.

4. The charging management method according to claim 1,
wherein the traveling object has an unmanned autonomous traveling function,
the charging management method further comprising:
causing the traveling object to autonomously travel to one of the at least one charging facility and the storage battery to be automatically charged, in accordance with the charging plan created in the creating.

5. The charging management method according to claim 4,
wherein in the creating, the charging plan is created to enable charging of the storage battery at a charging facility located in an area within which the traveling object is able to travel within a predetermined time period, the charging facility being one of the at least one charging facility.

6. The charging management method according to claim 4,
wherein in the creating, the charging plan is created to enable charging of the storage battery at a charging facility located in an area within which the traveling object is able to travel within a predetermined distance, the charging facility being one of the at least one charging facility.

7. The charging management method according to claim 4,
wherein in the creating, the charging plan is created to enable charging of the storage battery during a time period based on a schedule of a user of the traveling object.

8. The charging management method according to claim 1, further comprising:
presenting the charging plan created in the creating to a user of the traveling object.

9. The charging management method according to claim 8,
wherein the presenting includes presenting, to the user, implication information that encourages charging of the storage battery during a time period other than a peak time period during which the charging demand exceeds the predetermined value.

10. The charging management method according to claim 9,
wherein the implication information includes information indicating that a unit price of charging the storage battery during the peak time period is higher than a unit price of charging the storage battery during the time period other than the peak time period.

11. A non-transitory computer-readable recording medium having recorded thereon a program for causing at least one processor to perform the charging management method according to claim 1.

12. A charging management system comprising:
an obtainer that obtains location information, battery information, and history information, the location information being information on a location of a traveling object powered by electricity, the battery information being information on a remaining capacity of a storage battery mounted on the traveling object, the history information being information on a charging history of the storage battery;
a predictor that predicts a charging demand of at least one charging facility, based on the location information, the battery information, and the history information obtained by the obtainer; and
a planner that creates a charging plan for charging the storage battery to keep the charging demand less than or equal to a predetermined value, based on the charging demand predicted by the predictor.
